(19) United States
(12) Patent Application Publication
(10) Pub. No.: US 2025/0283567 A1
(43) Pub. Date: Sep. 11, 2025

(54) PIPE JOINT

(71) Applicant: IHARA SCIENCE CORPORATION, Tokyo (JP)

(72) Inventors: Keisuke MUSAKA, Izunokuni-shi (JP); Tatsuya ABE, Tendo-shi (JP); Yasuo FUJIWARA, Higashine-shi (JP)

(21) Appl. No.: 19/066,039

(22) Filed: Feb. 27, 2025

(30) Foreign Application Priority Data
Mar. 7, 2024 (JP) 2024-035125

(51) Int. Cl. F16L 37/373; F16K 5/06

(52) U.S. Cl. CPC F16L 37/373; F16K 5/06

(57) ABSTRACT

A pipe joint includes a first tubular body inserted into a second tubular body to be detachably connected to each other. The joint includes: a first valve including a first valve body that opens and closes a flow path in the first tubular body and a first rotating lever provided outside of the first tubular body and connected to and rotates the first valve body; a second valve configured to open and close a flow path in the second tubular body; and a sleeve movably provided on an outer peripheral surface of the second tubular body and configured to move toward the first tubular body to connect the tubular bodies to each other in an inserted state. The first rotating lever restricts the sleeve from moving when the flow path in the first tubular body is open, and the sleeve is allowed to move the flow path is closed.

### CROSS-REFERENCE TO RELATED APPLICATION

The present application claims priority from Japanese Patent Application No. 2024-035125 filed Mar. 7, 2024, which is incorporated herein by reference in its entirety.

### BACKGROUND OF THE INVENTION

### 1. Technical Field

The present invention relates to a pipe joint.

### 2. Description of the Related Art

There is a conventional pipe joint in which two joint halves, including a first tubular body and a second tubular body into which the first tubular body is inserted, are detachably connected to each other.

This type of pipe joint may, for example, include a rotary valve provided in each joint half and fix connection between the joint halves when at least one rotary valve is open, as disclosed in JP 2021-535344 A.

Specifically, this pipe joint is formed with a locking element having a convex shape on a valve shaft of a rotary valve, and a locking element having a concave shape on an outer peripheral surface of a mating joint half. A joint half rotates with respect to the mating joint half, and the rotary valve opens in a state where the locking element of the valve shaft and the locking element formed in the mating joint half are fitted together. The locking elements are fitted together in the state where the rotary valve is open, so that the joint halves are fixedly connected. As a result, erroneous operations such as erroneously decoupling the joint halves can be prevented.

Meanwhile, to fix the connection between the joint halves, the pipe joint described above requires the joint half to rotate with respect to the mating joint half before opening the rotary valve. To unfix the connection between the joint halves, on the other hand, the pipe joint described above requires the joint half to rotate with respect to the mating joint half after closing the rotary valve. Thus, the connection between the joint halves cannot be fixed or unfixed simply by opening and closing the rotary valve.

### PRIOR ART DOCUMENT

### Patent Document

Patent Document 1: JP 2021-535344 A

### SUMMARY OF THE INVENTION

Hence, a major object of the present invention is to provide a pipe joint, in which a first tubular body and a second tubular body into which the first tubular body is inserted are detachably connected to each other, capable of preventing erroneous operations such as erroneously decoupling the first tubular body and the second tubular body from each other and enabling the first tubular body and the second tubular body to attach to and detach from each other.

That is, a pipe joint in which a first tubular body and a second tubular body into which the first tubular body is inserted are detachably connected to each other includes: a first valve including a first valve body that opens and closes a flow path in the first tubular body and a first rotating lever provided outside of the first tubular body and connected to and rotates the first valve body, the first valve body and the first rotating lever being provided in the first tubular body; a second valve provided in the second tubular body and configured to open and close a flow path in the second tubular body; and a sleeve movably provided on an outer peripheral surface of the second tubular body and configured to move toward the first tubular body to connect the first tubular body and the second tubular body to each other in a state where the first tubular body is inserted into the second tubular body, in which the first rotating lever restricts the sleeve from moving in the outer peripheral surface when the first rotating lever is rotated to open the flow path in the first tubular body, and the restriction of the sleeve by the first rotating lever is released to allow the sleeve to move in the outer peripheral surface when the first rotating lever is rotated to close the flow path in the first tubular body.

The pipe joint configured as such is capable of, simply by rotating the first rotating lever, switching the coupling and decoupling between the first tubular body and the second tubular body without requiring other operations. The first rotating lever restricts the movement of the sleeve in the outer peripheral surface of the second tubular body along with the opening of the first valve; therefore, an erroneous operation in which the first tubular body is erroneously decoupled from the second tubular body can also be prevented when a fluid is flowing in the pipe joint.

In addition, the first tubular body and the second tubular body are respectively provided with valves; therefore, the first tubular body and the second tubular body can be attached to either an upstream and downstream regardless of a pressure on the upstream and the downstream.

An aspect of the pipe joint further includes: a protrusion formed on the first rotating lever and protruding from the first rotating lever toward an outer peripheral surface of the first tubular body; and a recess formed on an outer peripheral surface of the sleeve and fitted with the protrusion, in which in a state where the first tubular body is inserted into the second tubular body, the protrusion is in a fitted state with the recess when the first rotating lever is rotated to open the flow path in the first tubular body, and the fitted state is released when the rotating lever is rotated to close the flow path in the first tubular body.

With this configuration, the protrusion and the recess are fitted together when the fluid flows in the pipe joint; therefore, the movement of the sleeve can be restricted more reliably and the coupling of the first tubular body and the second tubular body can be further solidified.

The second valve includes: a second valve body configured to open and close the flow path in the second tubular body; and a second rotating lever provided outside of the second tubular body and connected to and rotates the second valve body, the sleeve is provided between the first rotating lever and the second rotating lever in a state where the first tubular body is inserted into the second tubular body, and the second rotating lever has a restricting surface that restricts movement of the sleeve toward the second rotating lever when the second rotating lever is rotated to open the flow path in the second tubular body.

With this configuration, the first rotating lever and the restricting surface restrict the movement of the sleeve when the flow path of the second tubular body is open, and thus both the first rotating lever and the second rotating lever needs to rotate for the sleeve to be movable. As a result, even if one valve is erroneously closed when the fluid is flowing in the pipe joint, the movement of the sleeve is restricted as long as the other valve remains open. The first tubular body can therefore be prevented from being erroneously decoupled from the second tubular body in a more reliable manner.

The first valve or the second valve is preferably a ball valve.

With this configuration, a diameter of the flow path is maximized in a state where the flow path is open; therefore, a fluid resistance can be reduced and a flow rate in the pipe joint can be increased compared to conventional quick joints.

The present invention described above provides a pipe joint, in which a first tubular body and a second tubular body into which the first tubular body is inserted are detachably connected to each other, capable of preventing erroneous operations such as erroneously decoupling the first tubular body and the second tubular body from each other and enabling the first tubular body and the second tubular body to attach to and detach from each other.

### BRIEF DESCRIPTION OF THE DRAWINGS

FIG. 1 is a perspective view of a pipe joint according to an embodiment of the present invention;

FIG. 2 is a sectional view of the pipe joint according to the embodiment;

FIG. 3 is a sectional view of the pipe joint according to the embodiment; and

FIG. 4 is a sectional view of the pipe joint according to the embodiment.

### DETAILED DESCRIPTION

Hereinafter, an embodiment of the present invention will be described with reference to the drawings. It should be noted that any of the drawings referred to below may be schematically omitted or exaggerated as appropriate for easy understanding. Same components are denoted by the same reference numerals, and description thereof will be omitted as appropriate.

### <Configuration of Apparatus>

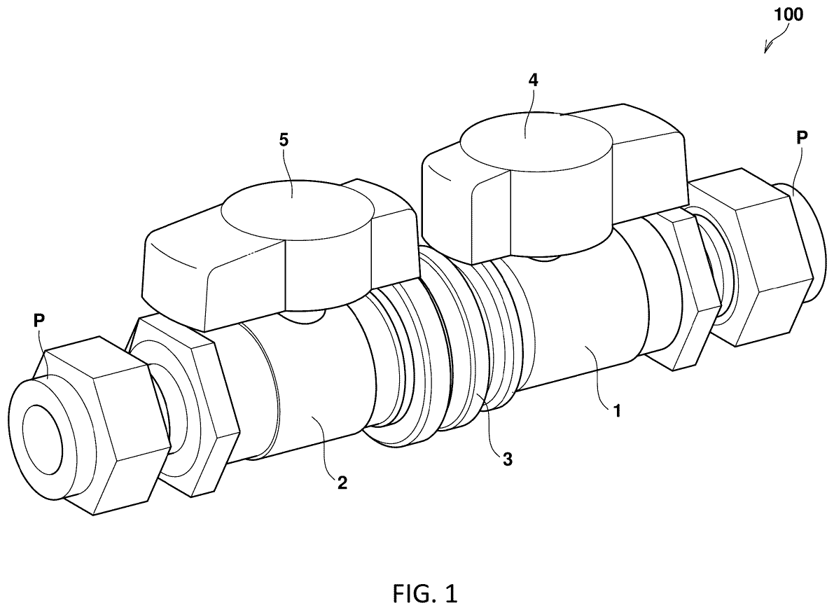

As illustrated in FIGS. 1 to 4, a pipe joint 100 of the present embodiment is a so-called quick joint including a first tubular body 1, a second tubular body 2 into which the first tubular body 1 is inserted, and a sleeve 3 that couples and fixes the first tubular body 1 and the second tubular body 2 together.

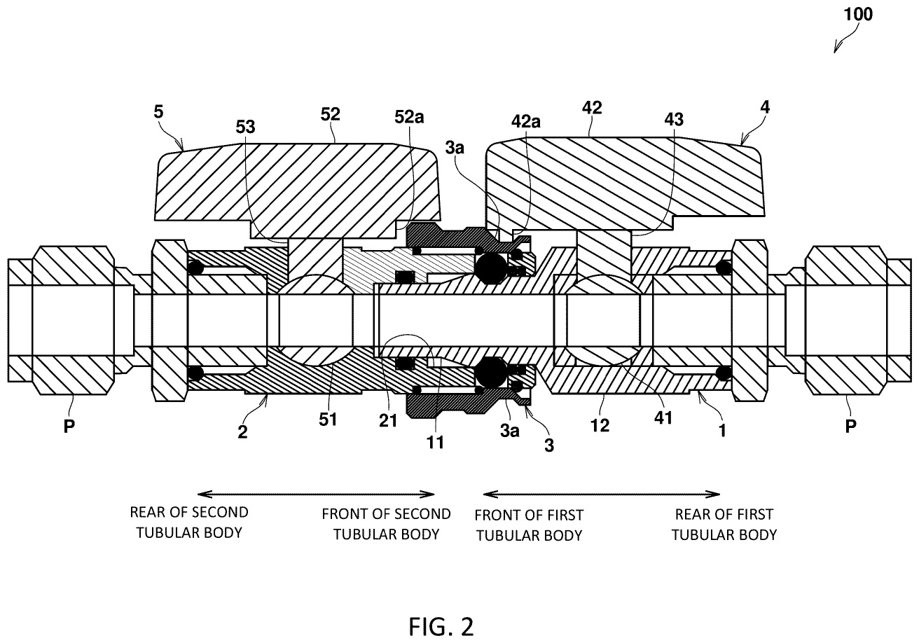

As illustrated in FIGS. 1 and 2, the first tubular body 1 has, for example, a cylindrical shape whose interior forms a flow path. Here, a direction into which the first tubular body 1 is inserted with respect to the second tubular body 2 is referred to as a front of the first tubular body 1, and a direction opposite to the direction into which the first tubular body 1 is inserted with respect to the second tubular body 2 is referred to as a rear of the first tubular body 1. A tubular member P is connected to a rear end of the first tubular body 1.

Specifically, the first tubular body 1 has a small-diameter portion 11 that is tapered at a distal end and is inserted into the second tubular body 2 while being connected to the second tubular body 2, and a large-diameter portion 12 provided at a rear of the small-diameter portion 11 and has an outer diameter larger than that of the small-diameter portion 11. In the present embodiment, an inner diameter of the small-diameter portion 11 and an inner diameter of the large-diameter portion 12 are substantially equal. In addition, a recess for providing a metal retaining member, which prevents the first tubular body from coming off from the second tubular body 2, is formed on an outer peripheral surface of the small-diameter portion 11.

As illustrated in FIGS. 1 to 4, the large-diameter portion 12 is provided with a first valve 4 that opens and closes the flow path of the first tubular body 1. Specifically, the first valve 4 includes a first valve body 41 provided in a flow path of the large-diameter portion 12 and a first rotating lever 42 provided outside of the first tubular body 1 and connected to and rotates the first valve body 41. In the present embodiment, the first valve 4, which is for example a ball valve, is opened and closed by an operator rotating the first rotating lever 42.

The first valve body 41 has a substantially spherical shape. A cylindrical flow path is formed, through the first valve body 41, at a center of the first valve body 41. The flow path formed in the first valve body 41 has an inner diameter substantially equal to that of the flow path of the first tubular body 1.

The first rotating lever 42 is connected to the first valve body 41 with a stem 43 interposed between the first rotating lever 42 and the first valve body 41. The first rotating lever 42 has a substantially rectangular parallelepiped shape. In the present embodiment, a longitudinal-direction component of the first rotating lever 42 is substantially parallel to a longitudinal-direction component of the flow path of the first tubular body 1 when the first valve 4 is open. On the other hand, the longitudinal-direction component of the first rotating lever 42 is substantially perpendicular to the longitudinal-direction component of the flow path of the first tubular body 1 when the first valve 4 is closed.

The first rotating lever 42 is also formed with a protrusion 42a protruding from the first rotating lever 42 toward an outer peripheral surface of the first tubular body 1. Specifically, the protrusion 42a is formed near a front of a facing surface of the first rotating lever 42, which is a surface facing the outer peripheral surface of the first tubular body 1. More specifically, the protrusion 42a protrudes from near the front of the facing surface of the first rotating lever 42 to an outer peripheral surface of the sleeve 3 when the first valve 4 is open.

As illustrated in FIGS. 1 and 2, the second tubular body 2 has, for example, a cylindrical shape whose interior forms a flow path. In the present embodiment, the flow path of the second tubular body 2 has an inner diameter substantially equal to that of the flow path of the first tubular body 1. Here, a direction into which the second tubular body 2 is inserted with respect to the first tubular body 1 is referred to as a front of the second tubular body 2, and a direction opposite to the direction into which the second tubular body 2 is inserted with respect to the first tubular body 1 is referred to as a rear of the second tubular body 2. A tubular member P is connected to the rear of the second tubular body 2.

Specifically, the second tubular body 2 includes an insertion recess 21 provided near a front of the second tubular body 2 and into which the small-diameter portion 11 is inserted. In the present embodiment, an inner diameter of the insertion recess 21 gradually decreases toward the rear of the second tubular body 2, a rear end of the insertion recess 21 is open-ended, and the inner diameter of the rear end of the insertion recess 21 is substantially equal to the inner diameter of the flow path of the second tubular body 2. A metal retaining member, which prevents the second tubular body 2 from coming off from the first tubular body 1, is formed in the insertion recess 21.

The sleeve 3 is movably provided on an outer peripheral surface of the second tubular body 2. The sleeve 3 moves, in the state where the small-diameter portion 11 is inserted into the insertion recess 21, toward the front of the second tubular body 2 to couple the first tubular body 1 and the second tubular body 2 together. Specifically, the sleeve 3 has a substantially cylindrical shape and is movable toward the front or rear of the second tubular body 2.

In addition, a recess 3a, which fits with the protrusion 42a in the state where the first valve 4 is open, is formed on the outer peripheral surface of the sleeve 3. Specifically, the recess 3a is formed, along a circumferential direction of the sleeve 3, near the front of the sleeve 3. In the present embodiment, the recess 3a is formed over an entire circumference of the sleeve 3; however, the recess 3a may be formed in a part of the circumferential direction of the sleeve 3.

As illustrated in FIGS. 1 to 4, the second tubular body 2 is provided with a second valve 5 that opens and closes the flow path of the second tubular body 2. Specifically, the second valve 5 includes a second valve body 51 provided backward of the insertion recess 21 in the flow path of the second tubular body 2, and a second rotating lever 52 provided outside of the second tubular body 2 and connected to and rotates the second valve body 51. In the present embodiment, the second valve 5, which is for example a ball valve, is opened and closed by the operator rotating the second rotating lever 52.

The second valve body 51 has a substantially spherical shape. A cylindrical flow path is formed, through the second valve body 51, at a central portion of the second valve body 51. The flow path formed in the second valve body 51 has an inner diameter substantially equal to that of the flow path of the second tubular body 2.

The second rotating lever 52 is connected to the second valve body 51 with a stem 53 interposed between the second rotating lever 52 and the second valve body 51. The second rotating lever 52 has a substantially rectangular parallelepiped shape. In the present embodiment, a longitudinal-direction component of the second rotating lever 52 is substantially parallel to a longitudinal-direction component of the flow path of the second tubular body 2 when the second valve 5 is open. On the other hand, the longitudinal-direction component of the second rotating lever 52 is substantially perpendicular to the longitudinal-direction component of the flow path of the second tubular body 2 when the second valve 5 is closed.

The second rotating lever 52 also has a restricting surface 52a that restricts movement of the sleeve 3 toward the second rotating lever 52 when the second rotating lever 52 is rotated to open the flow path of the second tubular body 2. The restricting surface 52a is provided to face a rear end surface of the sleeve 3 in the state where the second valve 5 is open. When the operator erroneously tries to move the sleeve 3 backward, this configuration allows the rear end of the sleeve 3 to hit the restricting surface 52a to restrict the sleeve 3 from moving backward beyond the restricting surface 52a. In the present embodiment, the restricting surface 52a is a part of a side surface of the second rotating lever 52.

In addition, in the present embodiment, a surface other than the restricting surface 52a, of the side surface of the second rotating lever 52 on which the restricting surface 52a is formed, is provided at a front of the second tubular body 2 and in front of the restricting surface 52a and outside the outer peripheral surface of the sleeve 3, that is, the outer side of the second tubular body 2 than the restricting surface 52a. This configuration is capable of preventing the second rotating lever 52 from being interfered by the sleeve 3 when the second rotating lever 52 rotates.

### <Detachment of First and Second Tubular Bodies>

First, the state in which the first valve 4 and the second valve 5 are open will be described with reference to FIG. 2.

In this state, the flow path of the first tubular body 1 and the flow path of the second tubular body 2 are coupled together to form one flow path. In addition, the first valve body 41 and the first rotating lever 42 are provided in the first tubular body 1, and the second valve body 51 and the second rotating lever 52 are provided in the second tubular body 2.

Further in this state, the sleeve 3 is provided between the stem 43 of the first valve 4 and the restricting surface 52a. Further, movement of the sleeve 3 with respect to the outer peripheral surface of the second tubular body 2 is restricted by the protrusion 42a of the first rotating lever 42 and the restricting surface 52a of the second rotating lever 52. Specifically, the protrusion 42a is in a fitted state with the recess 3a of the sleeve 3, so that the forward and backward movement of the sleeve 3 is restricted. In addition, when the operator erroneously tries to move the sleeve 3 backward, the rear end of the sleeve 3 hits the restricting surface 52a to restrict the sleeve 3 from moving backward beyond the restricting surface 52a.

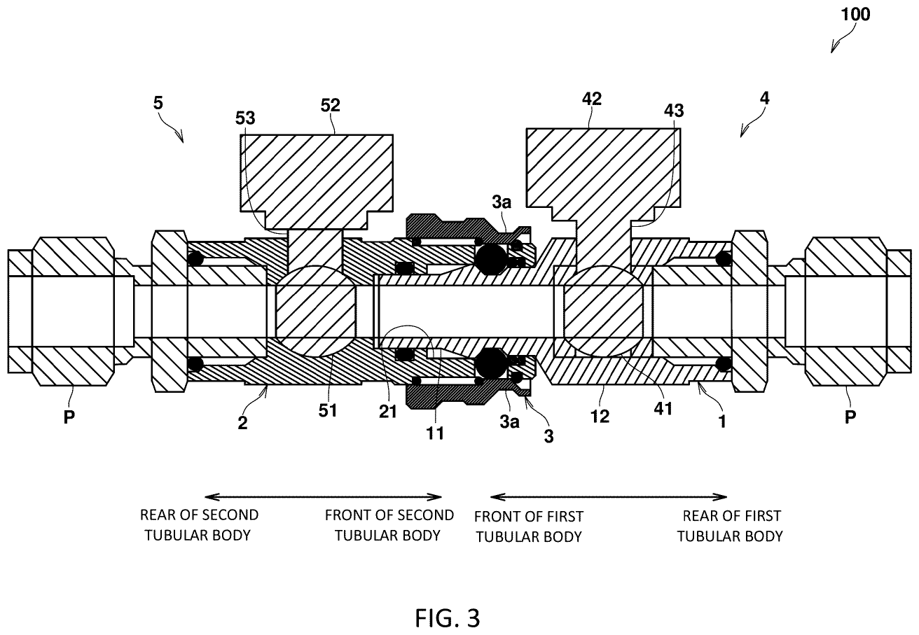

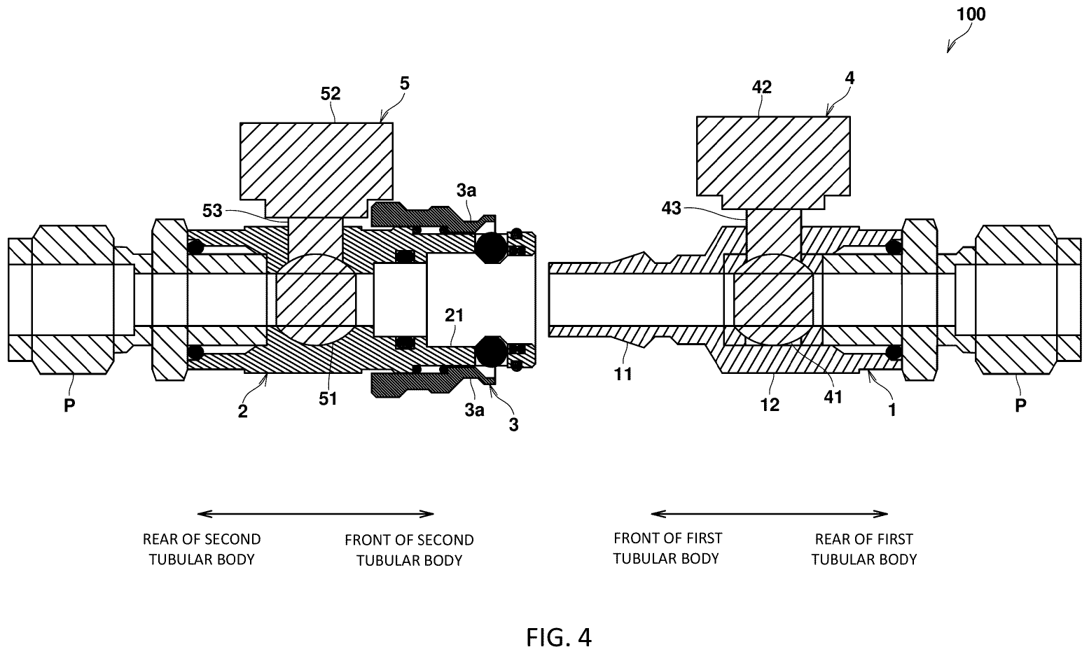

Next, attachment and detachment between the first tubular body 1 and the second tubular body 2 will be described with reference to FIGS. 3 and 4.

The first valve 4 and the second valve 5 respectively closes by the operator rotating the first rotating lever 42 and the second rotating lever 52, as illustrated in FIG. 3.

In the state where the first valve 4 and the second valve 5 are closed, the protrusion 42a is separated from the recess 3a of the sleeve 3 along with the rotation of the first rotating lever 42, which releases the fitted state in which the protrusion 42a fits with the recess 3a of the sleeve 3. In addition, the restricting surface 52a is separated from the rear end of the sleeve 3 along with the rotation of the second rotating lever 52, which releases restriction of the backward movement of the sleeve 3.

The sleeve 3 thus becomes movable with respect to the outer peripheral surface of the second tubular body 2. As a result, the first tubular body 1 can be removed from the second tubular body 2 by the operator moving the sleeve 3 from a distal end of the second tubular body 2 toward the second rotating lever 52, as illustrated in FIG. 4.

In the state where the first tubular body 1 is removed from the second tubular body 2, as in the state where the first tubular body 1 and the second tubular body 2 are coupled together, the first valve body 41 and the first rotating lever 42 are provided in the first tubular body 1, and the second valve body 51 and the second rotating lever 52 are provided in the second tubular body 2, as illustrated in FIG. 4.

### Effects of Present Embodiment

The pipe joint 100 configured as such is capable of, simply by rotating the first rotating lever 42 and the second rotating lever 52, switching the coupling and decoupling between the first tubular body 1 and the second tubular body 2 without requiring other operations. Additionally, the first rotating lever 42 restricts the movement of the sleeve 3 in the outer peripheral surface of the second tubular body 2 along with the opening of the first valve 4; therefore, an erroneous operation in which the first tubular body 1 is erroneously decoupled from the second tubular body 2 can also be prevented when a fluid is flowing in the pipe joint 100.

In addition, the first tubular body 1 and the second tubular body 2 are respectively provided with the first valve 4 and the second valve 5; therefore, the first tubular body 1 and the second tubular body 2 can be attached to either an upstream and downstream regardless of a pressure on the upstream and the downstream.

In addition, both the first valve body 41 and the first rotating lever 42 are provided in the same first tubular body 1; therefore, a pipe length of the first tubular body 1 can be shortened as compared to when a valve body and a rotating lever are provided in separate tubular bodies.

Additionally, the second valve body 51 and the second rotating lever 52 comprising the second valve 5 are provided in the second tubular body 2; therefore, a pipe length of the second tubular body 2 can also be shortened.

Moreover, the protrusion 42a and the recess 3a fit together when the fluid flows in the pipe joint 100; therefore, the movement of the sleeve 3 can be restricted more reliably and the coupling of the first tubular body 1 and the second tubular body 2 can be further solidified.

Further, the protrusion 42a and the restricting surface 52a restricts the movement of the sleeve 3, and thus both the first rotating lever 42 and the second rotating lever 52 needs to rotate for the sleeve 3 to be movable. As a result, even if one valve is erroneously closed when the fluid is flowing in the pipe joint 100, the movement of the sleeve 3 is restricted as long as the other valve remains open. The first tubular body 1 can therefore be prevented from being erroneously decoupled from the second tubular body 2 in a more reliable manner.

Additionally, the first valve 4 and the second valve 5 are constituted by ball valves, and thus a diameter of the flow path in the pipe joint 100 is maximized in the state where the first valve 4 and the second valve 5 are open. As a result, a fluid resistance can be reduced and a flow rate in the pipe joint 100 can be increased compared to conventional quick joints.

### Other Embodiments

The present invention is not limited to the embodiment described above.

In the embodiment described above, the restricting surface 52a is formed in the second rotating lever 52; however, the restricting surface 52a is not necessarily formed. In this case, simply by rotating the first rotating lever 42, switching of the coupling and decoupling between the first tubular body 1 and the second tubular body 2 can be achieved without requiring other operations.

In the embodiment described above, the protrusion 42a is formed in the first rotating lever 42; however, the configuration in which the first rotating lever 42 restricts the movement of the sleeve 3 is not restricted thereto. For example, the first rotating lever 42 may include a restricting surface provided to face a distal end of the sleeve 3 and restricts the forward movement of the sleeve 3.

In the embodiment described above, the restricting surface 52a is formed in the second rotating lever 52; however, the configuration in which the second rotating lever 52 restricts the backward movement of the sleeve 3 is not restricted thereto. For example, the backward movement of the sleeve 3 may be restricted by forming at a front of the second rotating lever 52 a protrusion protruding toward the outer peripheral surface of the second tubular body 2 and forming at a rear of the sleeve 3 a recess fitting with the protrusion of the second rotating lever 52.

In the embodiment described above, the restricting surface 52a is a part of the side surface near a distal end of the second rotating lever 52 in the state where the second valve 5 is open; however, the restricting surface 52a may constitute the entire side surface.

In the embodiment described above, the first valve 4 and the second valve 5 are constituted by ball valves; however, other types of valves may be employed in addition to a ball valve.

The present invention is not limited to the embodiments described above, and it goes without saying that various modifications can be made without departing from the gist of the present invention.

The present invention provides a pipe joint, in which a first tubular body and a second tubular body into which the first tubular body is inserted are detachably connected to each other, capable of preventing erroneous operations such as erroneously decoupling the first tubular body and the second tubular body from each other and enabling the first tubular body and the second tubular body to attach to and detach from each other.

| | |
|---|---|
| 100 | Pipe joint |
| 1 | First tubular body |
| 2 | Second tubular body |
| 3 | Sleeve |
| 3a | Recess |
| 4 | First valve |
| 41 | First valve body |
| 42 | First rotating lever |
| 42a | Protrusion |
| 5 | Second valve |
| 51 | Second valve body |
| 52 | Second rotating lever |
| 52a | Restricting surface |

What is claimed is:

1. A pipe joint in which a first tubular body and a second tubular body into which the first tubular body is inserted are detachably connected to each other, the pipe joint comprising:
a first valve including a first valve body that opens and closes a flow path in the first tubular body and a first rotating lever provided outside of the first tubular body and connected to and rotates the first valve body, the first valve body and the first rotating lever being provided in the first tubular body;
a second valve provided in the second tubular body and configured to open and close a flow path in the second tubular body; and
a sleeve movably provided on an outer peripheral surface of the second tubular body and configured to move toward the first tubular body to connect the first tubular body and the second tubular body to each other in a state where the first tubular body is inserted into the second tubular body,
wherein the first rotating lever restricts the sleeve from moving in the outer peripheral surface when the first rotating lever is rotated to open the flow path in the first tubular body, and the restriction of the sleeve by the first rotating lever is released to allow the sleeve to move in the outer peripheral surface when the first rotating lever is rotated to close the flow path in the first tubular body.

2. The pipe joint according to claim 1 further comprising:
a protrusion formed on the first rotating lever and protruding from the first rotating lever toward an outer peripheral surface of the first tubular body; and
a recess formed on an outer peripheral surface of the sleeve and fitted with the protrusion,
wherein in a state where the first tubular body is inserted into the second tubular body, the protrusion is in a fitted state with the recess when the first rotating lever is rotated to open the flow path in the first tubular body, and the fitted state is released when the rotating lever is rotated to close the flow path in the first tubular body.

3. The pipe joint according to claim 1, wherein
the second valve includes:
a second valve body configured to open and close the flow path in the second tubular body; and
a second rotating lever provided outside of the second tubular body and connected to and rotates the second valve body,
the sleeve is provided between the first rotating lever and the second rotating lever in a state where the first tubular body is inserted into the second tubular body, and
the second rotating lever has a restricting surface that restricts movement of the sleeve toward the second rotating lever when the second rotating lever is rotated to open the flow path in the second tubular body.

4. The pipe joint according to claim 1, wherein the first valve or the second valve is constituted by a ball valve.
